(19) United States
(12) Patent Application Publication
(10) Pub. No.: US 2013/0114024 A1
(43) Pub. Date: May 9, 2013

(54) DISPLAY APPARATUS AND ELECTRONIC EQUIPMENT

(71) Applicant: JAPAN DISPLAY WEST INC., Chita-gun (JP)

(72) Inventor: Hayato Kurasawa, Kanagawa (JP)

(73) Assignee: JAPAN DISPLAY WEST INC., CHITA-GUN (JP)

(21) Appl. No.: 13/661,604

(22) Filed: Oct. 26, 2012

(30) Foreign Application Priority Data
Nov. 7, 2011 (JP) 2011-243495

(51) Int. Cl. G02F 1/1335

(52) U.S. Cl. 349/96

(57) ABSTRACT

Disclosed herein is a display apparatus including: a display panel having a display area displaying an image; a touch sensor provided to overlap the surface of at least a portion of the display area; and an optical film which is provided so that a laminated layer formed on the lower-surface side of the display panel is thicker than a layer formed on the upper-surface side of the display panel and is provided with a view-angle compensation function.

### CROSS REFERENCES TO RELATED APPLICATIONS

The present application claims priority to Japanese Priority Patent Application JP 2011-243495 filed in the Japan Patent Office on Nov. 7, 2011, the entire content of which is hereby incorporated by reference.

### BACKGROUND

In general, the present application relates to display apparatus and electronic equipment. More particularly, the present application relates to display apparatus capable of preventing the sensitivity of a touch sensor employed in the display apparatus from deteriorating and relates to electronic equipment employing the display apparatus.

In recent years, a contact detection unit referred to as a touch panel is directly provided on a liquid-crystal display apparatus. In the following description, such a contact detection unit is also referred to as a touch sensor. In addition, a GUI (Graphical User Interface) for a variety of buttons is displayed on a liquid-crystal display apparatus. Thus, the liquid-crystal display apparatus is capable of inputting information from the GUI instead of inputting information from physical buttons, and the capability of inputting information from the GUI draws attention. The applicant for the present application has earlier proposed a display apparatus applied to mobile equipment as a display apparatus having a touch sensor (refer to, Japanese Patent Laid-open No. 2009-244958, for example).

In addition, a liquid-crystal display apparatus disclosed in Japanese Patent Laid-open No. 2007-218940 exhibits a view-angle compensation effect by providing a phase-difference plate.

### SUMMARY

By the way, if an optical film for view-angle compensation is used in a liquid-crystal panel having a touch sensor, the optical film such as the phase-difference plate is provided between an upper polarization plate and the liquid-crystal panel. The upper polarization plate is one of upper and lower polarization plates provided at positions above and below the liquid-crystal panel respectively. If the optical film is provided between the upper polarization plate and the liquid-crystal panel, the dielectric constant of the optical film decreases. It is thus quite within the bounds of possibility that the sensitivity of the touch sensor decreases.

For the reason described above, if an optical film for the view-angle compensation is used in a liquid-crystal panel having a touch sensor, it has been requested to prevent the sensitivity of the touch sensor from deteriorating.

There is a need for the present application addressing the problem described above to provide a liquid-crystal panel having a touch sensor with an optical film for the view-angle compensation in such a way that the liquid-crystal panel is made capable of preventing the sensitivity of the touch sensor from deteriorating.

A display apparatus according to a first embodiment of the present application includes: a display panel having a display area displaying an image; a touch sensor provided to overlap the surface of at least a portion of the display area; and an optical film which is provided so that a laminated layer formed on the lower-surface side of the display panel is thicker than a layer formed on the upper-surface side of the display panel and is provided with a view-angle compensation function.

The display panel includes a liquid-crystal panel driven by a horizontal electric-field method, an upper polarization plate provided on the upper-surface side of the liquid-crystal panel to transmit only light experiencing polarization determined in advance, and a lower polarization plate provided on the lower-surface side of the liquid-crystal panel to transmit only light experiencing polarization determined in advance. The optical film is provided between the liquid-crystal panel and the lower polarization plate.

The liquid-crystal panel, the upper polarization plate and the lower polarization plate are provided so that a transmission axis of the lower polarization plate is parallel to an initial orientation direction of a liquid-crystal layer of the liquid-crystal panel.

The liquid-crystal panel, the upper polarization plate and the lower polarization plate are provided so that an absorption axis of the lower polarization plate is perpendicular to the initial orientation direction of the liquid-crystal layer in a planar view.

The liquid-crystal panel has an electrode on which a plurality of slit-shaped apertures are formed. The electrode is provided so that the longitudinal direction of the slit-shaped apertures is parallel to the width direction of the liquid-crystal panel.

The optical film is a phase-difference plate.

The display panel includes a liquid-crystal panel driven by a vertical electric-field method, an upper polarization plate provided on the upper-surface side of the liquid-crystal panel to transmit only light experiencing polarization determined in advance, and a lower polarization plate provided on the lower-surface side of the liquid-crystal panel to transmit only light experiencing polarization determined in advance. The optical film has an upper optical film provided between the liquid-crystal panel and the upper polarization plate as well as a lower optical film provided between the liquid-crystal panel and the lower polarization plate. The optical film is formed so that the lower optical film is thicker than the upper optical film.

The upper optical film is a one-axis A plate for circular polarization of light, and the lower optical film is configured to include a one-axis A plate for circular polarization of light and a one-axis C plate for view-angle compensation.

The upper optical film is a one-axis A plate for circular polarization of light, and the lower optical film is configured to include a one-axis A plate for circular polarization of light and an O plate for view-angle compensation.

The touch sensor and the display panel are integrated with each other.

As described above, the display apparatus according to the first embodiment of the present application includes a display panel having a display area displaying an image; a touch sensor provided to overlap the surface of at least a portion of the display area and; optical films provided with a view-angle compensation function. In the display apparatus, the optical film is provided so that a laminated layer formed on the lower-surface side of the display panel is thicker than a layer formed on the upper-surface side of the display panel.

Electronic equipment according to a second embodiment of the present application includes a display apparatus including: a display panel having a display area displaying an image; a touch sensor provided to overlap the surface of at least a portion of the display area; and an optical film which is provided so that a laminated layer formed on the lower-surface side of the display panel is thicker than a layer formed on the upper-surface side of the display panel and is provided with a view-angle compensation function.

As described above, the electronic equipment according to the second embodiment of the present application includes a display apparatus including a display panel having a display area displaying an image, a touch sensor provided to overlap the surface of at least a portion of the display area and optical films provided with a view-angle compensation function. In the electronic equipment, the optical film is provided so that a layer formed on the lower-surface side of the display panel is thicker than a layer formed on the upper-surface side of the display panel.

In accordance with the first and second embodiments of the present application, it is possible to prevent the sensitivity of the touch sensor employed in the display apparatus from deteriorating.

Additional features and advantages are described herein, and will be apparent from the following Detailed Description and the figures.

### BRIEF DESCRIPTION OF THE FIGURES

FIGS. 1A and 1B are cross-sectional diagrams roughly showing a cross-sectional structure of a liquid-crystal display section according to a first embodiment of the present application;

FIG. 2 is a diagram showing a typical configuration of a liquid-crystal display section having an O-mode layout;

FIG. 3 is a diagram showing a typical configuration of a liquid-crystal display section having an E-mode layout;

FIG. 4 is a diagram showing a typical configuration of a liquid-crystal display section having an E-mode layout to serve as the liquid-crystal display section having horizontal slits;

FIGS. 5A and 5B are cross-sectional diagrams roughly showing a cross-sectional structure of a liquid-crystal display section according to a second embodiment of the present application; and

FIG. 6 is a diagram showing a typical configuration of a display apparatus according to an embodiment of the present application.

### DETAILED DESCRIPTION

Embodiments of the present application are explained by referring to the diagrams as follows.

It is to be noted that, as methods for applying an electric field to a liquid-crystal layer of a liquid-crystal display apparatus, there are known a horizontal electric-field method and a vertical electric-field method. In a liquid-crystal display apparatus adopting the horizontal electric-field method, a pair of substrates are provided to sandwich the liquid-crystal layer. On the inner-surface side of one of the substrates, a pair of electrodes insulated from each other are provided to serve as electrodes for applying an electric field to liquid-crystal molecules approximately in the horizontal direction. The liquid-crystal display apparatus adopting the horizontal electric-field method can have an FFS (Fringe Field Switching) mode or an IPS (In Plane Switching) mode. The FFS mode is a mode in which the electrodes are superposed on each other in a planar view whereas the IFS mode is a mode in which the electrodes are not superposed on each other in a planar view. In a liquid-crystal display apparatus adopting the vertical electric-field method, on the other hand, a pair of electrodes provided to sandwich a liquid-crystal layer apply an electric field to liquid-crystal molecules approximately in the vertical direction. The vertical electric-field method has a VA (Vertical Alignment) mode or a TN (Twisted Nematic) mode.

A first embodiment explained in the following description implements a liquid-crystal panel adopting the horizontal electric-field method in typically the FFS mode whereas a second embodiment explained in the following description implements a liquid-crystal panel adopting the vertical electric-field method in typically the VA mode.

### First Embodiment

### Cross-Sectional Diagram Showing Liquid-Crystal Display Section Adopting the Horizontal Electric-Field Method

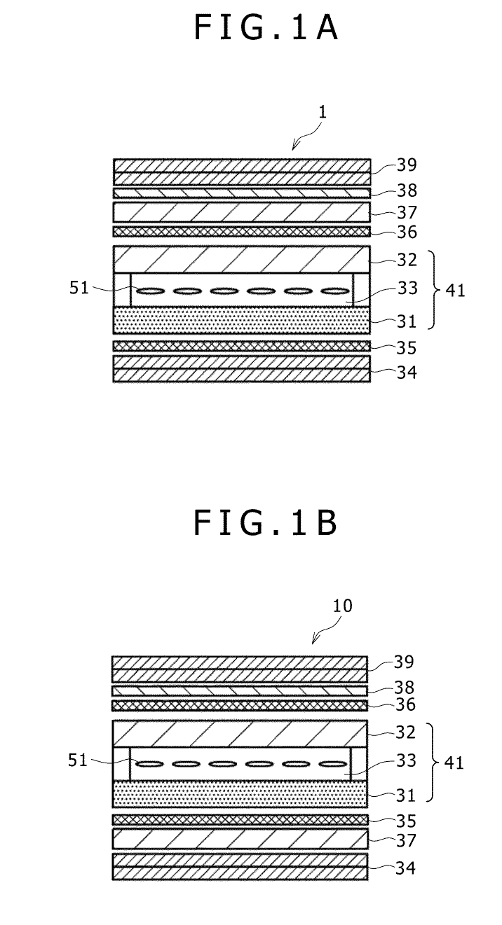

FIGS. 1A and 1B are cross-sectional diagrams roughly showing a cross-sectional structure of a liquid-crystal display section according to a first embodiment of the present application.

In the following description with reference to FIGS. 1A and 1B, in order to make the explanation of the structure of the liquid-crystal display section 10 easy to understand, the liquid-crystal display section 10 is described by comparing the liquid-crystal display section 10 with an ordinary liquid-crystal display section 1. That is to say, FIG. 1A shows the structure of the ordinary liquid-crystal display section 1 whereas FIG. 1B shows the structure of the liquid-crystal display section 10 of the present application.

The liquid-crystal display sections 1 and 10 shown in FIGS. 1A and 1B employ a liquid-crystal panel as a display panel. In addition, by making use of some electrodes employed originally in this liquid-crystal panel also as a source of a display driving signal, it is possible to provide a touch-sensor liquid-crystal panel 41 including a touch sensor having an in-cell type to serve as a touch sensor configured as an electrostatic-capacitance touch sensor.

The touch-sensor liquid-crystal panel 41 is composed of liquid crystals adopting the horizontal electric-field method in typically the FFS mode. The touch-sensor liquid-crystal panel 41 includes a pixel substrate 31, an opposite substrate 32 as well as a liquid-crystal layer 33 placed at a location between the pixel substrate 31 and the opposite substrate 32 which is provided at a location facing the pixel substrate 31. The liquid-crystal layer 33 has a plurality of liquid-crystal molecules 51 oriented in a direction approximately parallel to the surfaces of the pixel substrate 31 and the opposite substrate 32. The liquid-crystal layer 33 modulates light, which is propagating through the liquid-crystal layer 33, in accordance with the state of an electric field applied to the liquid-crystal layer 33.

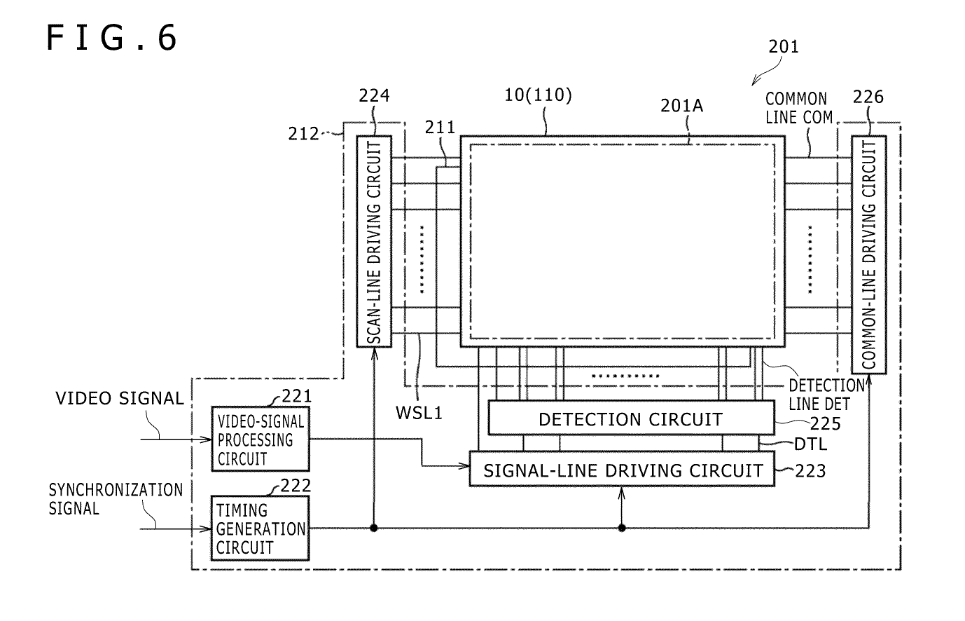

The liquid-crystal layer 33 is provided on a side receiving incident light from a backlight which is a backlight 211 shown in FIG. 6 to be described later. The pixel substrate 31 has a transparent substrate used as a circuit substrate and a plurality of pixel electrodes laid out to form a matrix on this transparent substrate.

On the other hand, the opposite substrate 32 is provided on a user side. The user side is a side from which light modulated by the liquid-crystal layer 33 is emitted. The opposite substrate 32 includes a transparent substrate, color filters formed on one of the surfaces of this transparent substrate and a common electrode formed on these color filters. The color filters are used to transmit predetermined light propagating through the filters. The light transmitted by the color filters are typically light having the three primary colors, that is, the red (R), green (G) and blue (B) colors.

The common electrode is used also as a sensor driving electrode composing a portion of the touch sensor for detecting a touch. In addition, on the other surface of the transparent substrate of the opposite substrate 32, a detection electrode for the touch sensor is formed. That is to say, in the touch-sensor liquid-crystal panel 41, a capacitance device is configured by making use of a pair of electrodes, that is, the detection electrode for the touch sensor and the common electrode provided at a location facing the detection electrode. The capacitance device having such a configuration allows the touch-sensor liquid-crystal panel 41 to detect typically a finger of the user.

In addition, as shown in FIG. 1A, in the ordinary liquid-crystal display section 1, a polarization plate 34 is pasted on the backlight-side surface of the pixel substrate 31 through an adhesion layer 35. Furthermore, a stack including a phase-difference plate 37, a conductive layer 38 and a polarization plate 39 is pasted on the user-side surface of the opposite substrate 32 through an adhesion layer 36. The stack is formed by laminating the phase-difference plate 37, the conductive layer 38 and the polarization plate 39 in the same order as the order in which the phase-difference plate 37, the conductive layer 38 and the polarization plate 39 are enumerated in this sentence. The polarization plate 34 and the polarization plate 39 are a sort of optical shutter. This optical shutter transmits only polarized light which is light having a certain vibration direction. The phase-difference plate 37 is an optical film having a view-angle compensation function whereas the conductive layer 38 is provided as a countermeasure against static electricity.

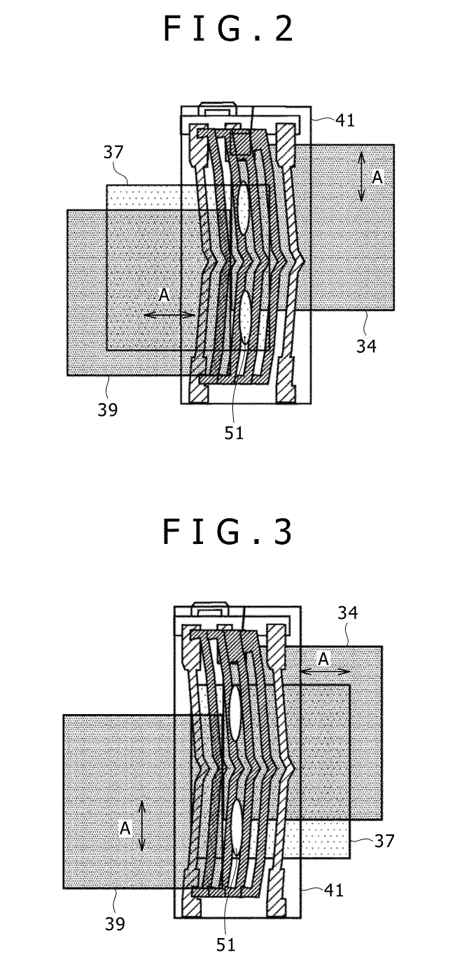

As described above, the ordinary liquid-crystal display section 1 shown in FIG. 1A includes the polarization plate 39 provided on the upper-surface side of the touch-sensor liquid-crystal panel 41 and the polarization plate 34 provided on the lower-surface side of the touch-sensor liquid-crystal panel 41 whereas the phase-difference plate 37 is provided between the polarization plate 39 and the touch-sensor liquid-crystal panel 41. For example, as shown in FIG. 2, the touch-sensor liquid-crystal panel 41 in the FFS mode, the polarization plate 34 and the polarization plate 39 are provided in an O-mode configuration where the initial orientation direction of the liquid-crystal molecules 51 and an absorption axis A of the polarization plate 34 are parallel to each other. In this configuration, the phase-difference plate 37 is generally provided between the polarization plate 39 and the touch-sensor liquid-crystal panel 41.

If the phase-difference plate 37 is provided between the polarization plate 39 and the touch-sensor liquid-crystal panel 41 as described above, however, the small dielectric constant of the phase-difference plate 37 may undesirably reduce the sensitivity of the touch sensor in some cases. In addition, in the touch-sensor liquid-crystal panel 41 having the in-cell type, it is necessary to provide the conductive layer 38 serving as a countermeasure against static electrical charge inside the configuration of the polarization plate 39. Due to a combination of the phase-difference plate 37 and the conductive layer 38 which are provided on the upper-surface side of the touch-sensor liquid-crystal panel 41, however, it is quite within the bounds of possibility that the sensitivity of the touch sensor is further decreased.

In order to solve the problem described above, in the liquid-crystal display section 10, the phase-difference plate 37 is provided between the touch-sensor liquid-crystal panel 41 and the polarization plate 34 as shown in FIG. 1B. By providing the phase-difference plate 37 between the touch-sensor liquid-crystal panel 41 and the polarization plate 34, only the conductive layer 38 and the adhesion layer 36 are formed between the polarization plate 39 and the touch-sensor liquid-crystal panel 41 so that it is possible to prevent the phase-difference plate 37 from affecting the sensitivity of the touch sensor. As a result, it is possible to prevent the sensitivity of the touch sensor from deteriorating.

In addition, in the structure of the liquid-crystal display section 10, the phase-difference plate 37 and the conductive layer 38 can be configured separately from each other. Thus, it is possible to suppress an effect of the combination including the phase-difference plate 37 and the conductive layer 38 on the sensitivity of the touch sensor and, thus, prevent the sensitivity of the touch sensor from deteriorating.

By the way, if the layout according to the O-mode configuration is adopted when providing the phase-difference plate 37 between the touch-sensor liquid-crystal panel 41 and the polarization plate 34 in the liquid-crystal display section 10, as generally known, the view-angle characteristic may be lost in some cases. In order to solve this problem, the touch-sensor liquid-crystal panel 41, the polarization plate 34 and the polarization plate 39 can be laid out in the liquid-crystal display section 10 in accordance with an E-mode configuration in which the initial orientation direction of liquid-crystal molecules 51 and the absorption axis A of the polarization plate 34 are perpendicular to each other as shown in FIG. 3. Thus, it is not only possible to prevent the sensitivity of the touch sensor from deteriorating, but also possible to implement a large view angle. It is to be noted that, in the layout according to the E-mode configuration, the touch-sensor liquid-crystal panel 41, the polarization plate 39 and the polarization plate 34 are laid out so that the transmission axis of the polarization plate 34 and the initial orientation direction of the liquid-crystal molecules 51 in the liquid-crystal layer 33 are parallel to each other. As an alternative, in the layout according to the E-mode configuration, the touch-sensor liquid-crystal panel 41, the polarization plate 39 and the polarization plate 34 are laid out so that the absorption axis A of the polarization plate 34 and the initial orientation direction of the liquid-crystal molecules 51 are perpendicular to each other in a planar view.

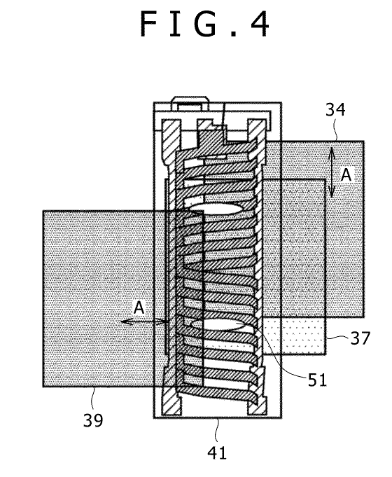

In addition, when the user looks at the liquid-crystal display section 10, which adopts the layout according to the E-mode configuration shown in FIG. 3, through polarization eye glasses such as polarization sunglasses, as generally known, the user is not capable of seeing a video picture displayed on the liquid-crystal display section 10. In order to solve this problem, the liquid-crystal display section 10 is configured into a typical configuration shown in FIG. 4. In this typical configuration, electrodes provided on either the pixel substrate 31 included in the touch-sensor liquid-crystal panel 41 or the opposite substrate 32 also included in the touch-sensor liquid-crystal panel 41 are formed in the shape of a comb. In addition, these electrodes in the shape of a comb are laid out to form horizontal slits. That is to say, the touch-sensor liquid-crystal panel 41 has electrodes on which a plurality of slit-shaped apertures are formed. These electrodes are provided so that the longitudinal direction of the slit-shaped apertures is parallel to the width direction of the touch-sensor liquid-crystal panel 41. At that time, the touch-sensor liquid-crystal panel 41, the polarization plate 34 and the polarization plate 39 are laid out in an E-mode configuration as shown in FIG. 4. Thus, even if the layout according to the E-mode configuration is adopted, the user is capable of seeing a video picture on the liquid-crystal display section 10 through polarization eye glasses.

It is to be noted that, in the liquid-crystal display section 10 adopting the layout according to the E-mode configuration shown in FIG. 4, the electrodes having the shape of a comb are laid out to form horizontal slits. Thus, in comparison with a case in which the layout according to the E-mode configuration shown in FIG. 3 is adopted, the aperture ratio of the pixel decreases. In order to solve this problem, in the touch-sensor liquid-crystal panel 41, the so-called triple gate structure is adopted in order to make the shape of the pixel long in the horizontal direction. In this way, even if the layout of the horizontal slits is adopted, the aperture is not lost so that it is possible to implement a touch sensor with a high sensitivity and implement a large view angle.

As described above, in the first embodiment, the optical film including the phase-difference plate 37 is provided between the touch-sensor liquid-crystal panel 41 and the polarization plate 34 so that a layer formed on the lower-surface side of the touch-sensor liquid-crystal panel 41 is thicker than a layer formed on the upper-surface side of the touch-sensor liquid-crystal panel 41. As a result, it is possible to prevent the sensitivity of the touch sensor from deteriorating.

In addition, by providing the phase-difference plate 37 on the lower-surface side of the touch-sensor liquid-crystal panel 41, the phase-difference plate 37 can be used to block noises coming from a peripheral circuit for the touch-sensor liquid-crystal panel 41. A typical example of such a circuit is a peripheral circuit 212 shown in FIG. 6 to be described later. As a result, typically, it is possible to increase the sensitivity of the touch sensor.

It is to be noted that, in the liquid-crystal display section 10 shown in FIG. 1B, a phase-difference plate such as a λ/4 plate can be further provided on the upper-surface side of the polarization plate 39 so that the user is capable of seeing a video picture on the liquid-crystal display section 10 through polarization eye glasses even if the layout according to the E-mode shown in FIG. 3 is adopted. In addition, in this case, the phase-difference plate is provided on each of the upper-surface and lower-surface sides of the touch-sensor liquid-crystal panel 41. Thus, the thickness of the layer formed on the upper-surface side can be made about equal the thickness of the layer formed on the lower-surface side. As a result, such a configuration also provides an effective reflex countermeasure against heat generated in the liquid-crystal display section 10 having a particularly large display area.

### Second Embodiment

### Cross-Sectional Diagram Showing Liquid-Crystal Display Section Adopting the Horizontal Electric-Field Method

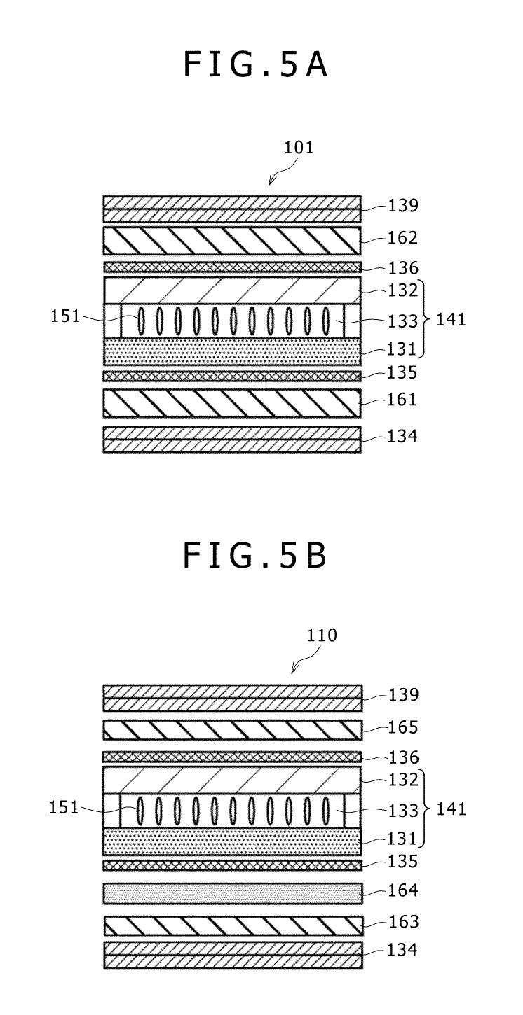

FIGS. 5A and 5B are cross-sectional diagrams roughly showing a cross-sectional structure of a liquid-crystal display section 110 according to a second embodiment of the present application. It is to be noted that, FIGS. 5A and 5B are given in the same way as FIGS. 1A and 1B. That is to say, FIG. 5A shows the structure of an ordinary liquid-crystal display section 101 whereas FIG. 5B shows the structure of the liquid-crystal display section 110 of the present application.

The liquid-crystal display sections 101 and 110 shown in FIGS. 5A and 5B employ a liquid-crystal panel as a display panel. In addition, it is possible to provide a touch-sensor liquid-crystal panel 141 including a touch sensor having an in-cell type to serve as a touch sensor configured to carry out the functions of an electrostatic-capacitance touch sensor.

The touch-sensor liquid-crystal panel 141 is composed of liquid crystals adopting the vertical electric-field method in typically the VA mode. The touch-sensor liquid-crystal panel 141 includes a pixel substrate 131, an opposite substrate 132 as well as a liquid-crystal layer 133 placed at a location between the pixel substrate 131 and the opposite substrate 132 which is provided at a location facing the pixel substrate 131. The liquid-crystal layer 133 has a plurality of liquid-crystal molecules 151 oriented in a direction approximately perpendicular to the surfaces of the pixel substrate 131 and the opposite substrate 132. The liquid-crystal layer 133 modulates light, which is propagating through the liquid-crystal layer 133, in accordance with the state of an electric field applied to the liquid-crystal layer 133. In addition, in the same way as the pixel substrate 31 and the opposite substrate 32, the pixel substrate 131 and the opposite substrate 132 function as an electrostatic-capacitance touch sensor capable of detecting typically a finger of the user.

In this case, as shown in FIG. 5A, in the touch-sensor liquid-crystal panel 141 in the VA mode, in order to improve the visibility of a displayed black color for example, two circular-polarization plates are provided above and below the touch-sensor liquid-crystal panel 141 respectively so that layers provided on the upper-surface side of the touch-sensor liquid-crystal panel 141 and layers provided on the lower-surface side of the touch-sensor liquid-crystal panel 141 are generally formed symmetrically with respect to the touch-sensor liquid-crystal panel 141. That is to say, in the ordinary liquid-crystal display section 101, on the backlight-side surface of the pixel substrate 131, a polarization plate 134 and a two-axis λ/4 plate 161 are formed in the same order as the order in which the polarization plate 134 and the two-axis λ/4 plate 161 are enumerated in this sentence in order to form a stack pasted to the pixel substrate 131 through an adhesion layer 135. By the same token, on the user-side surface of the opposite substrate 132, a two-axis λ/4 plate 162 and a polarization plate 139 are formed in the same order as the order in which the two-axis λ/4 plate 162 and the polarization plate 139 are enumerated in this sentence in order to form a stack pasted to the opposite substrate 132 through an adhesion layer 136. In the configuration described above, the two-axis λ/4 plate 161 and the two-axis λ/4 plate 162 are provided to form a pair composing of two-axis phase-difference plates which are each a typical phase-difference plate. For example, the two-axis λ/4 plate 161 and the two-axis λ/4 plate 162 can be provided to serve as an A plate and a C plate. On the other hand, in the same way as the polarization plate 34 and the polarization plate 39 which have been described earlier, the polarization plate 134 and the polarization plate 139 are each configured to serve as an optical shutter for transmitting only certain polarized light which is light having a certain vibration direction.

As described above, if the two-axis λ/4 plate 162 having a thickness to a certain degree is provided between the polarization plate 139 and the touch-sensor liquid-crystal panel 141, in the same way as the ordinary liquid-crystal display section 1 described before by referring to FIG. 1A, the sensitivity of the touch sensor inevitably decreases in some cases. In addition, it is not necessary to ideally provide a phase difference in the Z-axis direction symmetrically on the upper-surface and lower-surface sides of the touch-sensor liquid-crystal panel 141. That is to say, the phase difference in the Z-axis direction can be provided on either the upper-surface side or the lower-surface side. The phase difference in the Z-axis direction is one of the two-axis phase differences. Thus, in the liquid-crystal display section 110 according to the present application, the phase difference in the Z-axis direction is moved from the upper-surface side of the touch-sensor liquid-crystal panel 141 to the lower-surface side of the touch-sensor liquid-crystal panel 141 as shown in FIG. 5B so that the phase-difference plate on the upper-surface side becomes thinner.

To put it concretely, on the upper-surface side of the touch-sensor liquid-crystal panel 141, the adhesion layer 136, a λ/4 plate 165 and the polarization plate 139 are formed in the same order as the order, in which the adhesion layer 136, the λ/4 plate 165 and the polarization plate 139 are enumerated in this sentence, so as to form a stack. On the lower-surface side of the touch-sensor liquid-crystal panel 141, on the other hand, the polarization plate 134, a λ/4 plate 163, a negative C plate 164 and the adhesion layer 135 are formed in the same order as the order, in which the polarization plate 134, the λ/4 plate 163, the negative C plate 164 and the adhesion layer 135 are enumerated in this sentence, so as to form a stack. In other words, in the liquid-crystal display section 110, a one-axis A plate for circular polarization is provided on each of the upper-surface and lower-surface sides of the touch-sensor liquid-crystal panel 141 and, in addition, on the lower-surface side of the touch-sensor liquid-crystal panel 141, a one-axis C plate for view-angle compensation is provided. Thus, by making use of the upper-surface side of the touch-sensor liquid-crystal panel 141 as a side including only the one-axis A plate, the upper-surface side of the touch-sensor liquid-crystal panel 141 can be made thinner. On the other hand, the one-axis C plate for view-angle compensation is included only on the lower-surface side of the touch-sensor liquid-crystal panel 141. As a result, it is possible to reduce the thickness of the layer formed on the upper-surface side of the touch-sensor liquid-crystal panel 141 while sustaining the optical performance of the touch-sensor liquid-crystal panel 141.

It is to be noted that, on the lower-surface side of the touch-sensor liquid-crystal panel 141, it is also possible to provide an O plate or a two-axis phase-difference plate in place of the one-axis C plate for view-angle compensation.

Let notations nx, ny and nz denote the refraction indexes in the phase-retardation direction, the phase-advancement direction and the thickness direction, respectively. In this case, the A plate is defined as a plate exhibiting a refraction-index distribution in which the relations nx>ny=nz hold true whereas the C plate is defined as a plate exhibiting a refraction-index distribution in which the relations nx=ny>nz hold true. On the other hand, the O plate is defined as a plate in which, in accordance with the phase-advancement direction or phase-retardation direction of a material used for forming the compensation layer, an optical axis prescribing a direction generating no double refraction is oriented in a direction inclined with respect to the light transmission surface.

As described above, in the second embodiment, for example, on the upper-surface side of the touch-sensor liquid-crystal panel 141, an optical film such as a one-axis A plate for circular polarization is provided whereas, on the lower-surface side of the touch-sensor liquid-crystal panel 141, optical films such as a one-axis A plate for circular polarization and a one-axis C plate for view-angle compensation are provided. Thus, the laminated layer provided on the lower-surface side of the touch-sensor liquid-crystal panel 141 is thicker than the layer provided on the upper-surface side of the touch-sensor liquid-crystal panel 141. As a result, it is possible to prevent the sensitivity of the touch sensor from deteriorating.

[Typical Configuration of Display Apparatus]

FIG. 6 is a diagram showing a typical configuration of a display apparatus according to an embodiment of the present application.

The display apparatus 201 is a display apparatus having a touch sensor. That is to say, the display apparatus 201 includes the liquid-crystal display section 10 or the liquid-crystal display section 110. As described above, the liquid-crystal display section 10 or the liquid-crystal display section 110 has an electrostatic-capacitance touch sensor embedded in the liquid-crystal panel serving as a display panel. In this configuration, some electrodes originally employed in the liquid-crystal panel also serve as a source of power used for driving the touch sensor. In addition to the liquid-crystal display section 10 (or 110), the display apparatus 201 also includes a backlight 211 and a peripheral circuit 212.

As described above, by changing the layout of the liquid-crystal molecules 51 (or 151), the liquid-crystal display section 10 (or 110) transmits and modulates light coming from the backlight 211 serving as a light source, displaying a video picture. The liquid-crystal display section 10 (or 110) has a plurality of pixels laid out to form a matrix. Each of the pixels is driven in accordance with a video-picture signal. Each of the pixels is connected to a scan line WSLN1 and a common connection line COM which are stretched in the horizontal direction and connected to a signal line DTL stretched in the vertical direction.

The backlight 211 is provided at a location behind the liquid-crystal display section 10 (or 110) and used for radiating light to the liquid-crystal display section 10 (or 110). The backlight 211 is a surface light source which can be any of a variety of light sources such as an LED (Light Emitting Diode), an HCFL (Hot Cathode Fluorescent Lamp) and a CCFL (Cold Cathode Fluorescent Lamp). As shown in none of the figures, the backlight 211 can have a structure in which a plurality of such light sources are laid out to cover the entire display surface. As an alternative, the backlight 211 can also have a structure in which a light guiding plate is used and the light sources are laid out over the side surfaces of the light guiding plate. In addition, on the light emission surface of the backlight 211, a variety of optical films can also be typically formed to form a stack. Typical examples of the optical films include a diffusion plate, a diffusion sheet, a lens film and a polarized-light separation sheet.

The peripheral circuit 212 carries out display driving operations and sensor driving operations in the liquid-crystal display section 10 (or 110). In addition, the peripheral circuit 212 detects sensor outputs. The peripheral circuit 212 is configured to include a video-signal processing circuit 221, a timing generation circuit 222, a signal-line driving circuit 223, a scan-line driving circuit 224, a detection circuit 225 and a common-line driving circuit 226.

The video-signal processing circuit 221 corrects a digital video signal typically received from an external source and converts the corrected digital video signal into an analog video signal. Then, the video-signal processing circuit 221 outputs the analog video signal to the signal-line driving circuit 223. The timing generation circuit 222 typically carries out control so that the signal-line driving circuit 223 and the scan-line driving circuit 224 operate in an interlocked manner. For example, the timing generation circuit 222 outputs control signals to the signal-line driving circuit 223 and the scan-line driving circuit 224 in accordance with synchronization signals received from an external source. That is to say, the timing generation circuit 222 synchronizes the signal-line driving circuit 223 and the scan-line driving circuit 224 to the synchronization signals. The signal-line driving circuit 223 writes the analog video signal received from the video-signal processing circuit 221 into a selected pixel. In accordance with a control signal received from the timing generation circuit 222, that is, in synchronization with the synchronization signal, the scan-line driving circuit 224 sequentially applies select pulses to a plurality of scan lines WSL1 in order to sequentially select a plurality of pixels connected to the scan line WSL1 receiving the select pulse. In accordance with a control signal received from the timing generation circuit 222, that is, in synchronization with the synchronization signal, the common-line driving circuit 226 also sequentially applies select pulses to a plurality of common lines COM in order to sequentially drive a plurality of common electrodes connected to a common line COM receiving the select pulse.

On the basis of detection signals received from a plurality of detection electrodes, the detection circuit 225 determines whether or not a detection object such as a finger of the user has been brought into contact with an image display surface 201A or has made an approach to the image display surface 201A. If the detection circuit 225 determines that the detection object has been brought into contact with the image display surface 201A or has made an approach to the image display surface 201A on the basis of the detection signals received from the detection electrodes, the detection circuit 225 computes the coordinates of the contact position of the detection object in the image display surface 201A on the basis of a timing to apply a select pulse to the common electrode and a timing to detect a detection signal not exceeding a threshold voltage Vth.

The display apparatus 201 is configured as follows.

It is to be noted that the display apparatus 201 shown in FIG. 6 can be applied to electronic equipment in all fields. The electronic equipment typically includes a digital television receiver, a digital camera, a notebook personal computer, a tablet computer, a video camera and a portable terminal such as a mobile phone or a smart phone. In other words, the display apparatus 201 can be applied to electronic equipment used in all fields as equipment for displaying a video signal in the form of an image or a video picture. In this case, the video signal can be a signal received from an external source or a signal generated internally in the display apparatus 201.

In addition, the touch-sensor liquid-crystal panel 41 having a touch sensor of the in-cell type has been described above. However, it is also possible to integrate a touch sensor of another type such as an on-cell type or an out-cell type with the panel. As an alternative, it is also possible to separate a touch sensor from the panel.

On top of that, the above descriptions have explained a typical display apparatus employing a liquid-crystal panel provided with a liquid-crystal layer to serve as a display panel. However, implementations of the present application are by no means limited to such a configuration. That is to say, the present application can also be applied to other display panels. In addition, an electrostatic-capacitance touch sensor has been explained as an example of the touch sensor. However, implementations of the present application are by no means limited to such a configuration. That is to say, the present application can also be applied to touch sensors of other types.

It is to be noted that implementations of the present application are by no means limited to the embodiments described above. That is to say, the embodiments can be modified in a variety of ways within a range not deviating from essentials of the present application.

In addition, the present application can be realized into the following implementations.

(1) A display apparatus including:

a display panel having a display area displaying an image;

a touch sensor provided to overlap the surface of at least a portion of the display area; and

an optical film which is provided so that a laminated layer formed on the lower-surface side of the display panel is thicker than a layer formed on the upper-surface side of the display panel and is provided with a view-angle compensation function.

(2) The display apparatus according to implementation (1), wherein

the display panel includes
a liquid-crystal panel driven by a horizontal electric-field method,
an upper polarization plate provided on the upper-surface side of the liquid-crystal panel to transmit only light experiencing polarization determined in advance, and
a lower polarization plate provided on the lower-surface side of the liquid-crystal panel to transmit only light experiencing polarization determined in advance; and

the optical film is provided between the liquid-crystal panel and the lower polarization plate.

(3) The display apparatus according to implementation (2), wherein

the liquid-crystal panel, the upper polarization plate and the lower polarization plate are provided so that a transmission axis of the lower polarization plate is parallel to an initial orientation direction of a liquid-crystal layer of the liquid-crystal panel or so that an absorption axis of the lower polarization plate is perpendicular to the initial orientation direction of the liquid-crystal layer in a planar view.

(4) The display apparatus according to implementation (3), wherein

the liquid-crystal panel has an electrode on which a plurality of slit-shaped apertures are formed; and

the electrode is provided so that the longitudinal direction of the slit-shaped apertures is parallel to the width direction of the liquid-crystal panel.

(5) The display apparatus according to any one of implementations (2) to (4), wherein

the optical film is a phase-difference plate.

(6) The display apparatus according to implementation (1), wherein

the display panel includes
a liquid-crystal panel driven by a vertical electric-field method,
an upper polarization plate provided on the upper-surface side of the liquid-crystal panel to transmit only light experiencing polarization determined in advance, and
a lower polarization plate provided on the lower-surface side of the liquid-crystal panel to transmit only light experiencing polarization determined in advance;

the optical film has an upper optical film provided between the liquid-crystal panel and the upper polarization plate as well as a lower optical film provided between the liquid-crystal panel and the lower polarization plate; and

the optical film is formed so that the lower optical film is thicker than the upper optical film.

(7) The display apparatus according to implementation (6), wherein

the upper optical film is a one-axis A plate for circular polarization of light, and

the lower optical film is configured to include a one-axis A plate for circular polarization of light and a one-axis C plate or an O plate either of which is used for view-angle compensation.

(8) The display apparatus according to any one of implementations (1) to (7), wherein

the touch sensor and the display panel are integrated with each other.

(9) Electronic equipment including a display apparatus including:

a display panel having a display area displaying an image;

a touch sensor provided to overlap the surface of at least a portion of the display area; and

an optical film which is provided so that a laminated layer formed on the lower-surface side of the display panel is thicker than a layer formed on the upper-surface side of the display panel and is provided with a view-angle compensation function.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A display apparatus comprising:
a display panel having a display area displaying an image;
a touch sensor provided to overlap the surface of at least a portion of said display area; and
an optical film which is provided so that a laminated layer formed on the lower-surface side of said display panel is thicker than a layer formed on the upper-surface side of said display panel and is provided with a view-angle compensation function.

2. The display apparatus according to claim 1, wherein
said display panel includes:
a liquid-crystal panel driven by a horizontal electric-field method,
an upper polarization plate provided on said upper-surface side of said liquid-crystal panel to transmit only light experiencing polarization determined in advance, and
a lower polarization plate provided on said lower-surface side of said liquid-crystal panel to transmit only light experiencing polarization determined in advance; and
said optical film is provided between said liquid-crystal panel and said lower polarization plate.

3. The display apparatus according to claim 2, wherein
said liquid-crystal panel, said upper polarization plate and said lower polarization plate are provided so that a transmission axis of said lower polarization plate is parallel to an initial orientation direction of a liquid-crystal layer of said liquid-crystal panel.

4. The display apparatus according to claim 3, wherein
said liquid-crystal panel has an electrode on which a plurality of slit-shaped apertures are formed; and
said electrode is provided so that the longitudinal direction of said slit-shaped apertures is parallel to the width direction of said liquid-crystal panel.

5. The display apparatus according to claim 2, wherein
said liquid-crystal panel, said upper polarization plate and said lower polarization plate are provided so that an absorption axis of said lower polarization plate is perpendicular to said initial orientation direction of said liquid-crystal layer in a planar view.

6. The display apparatus according to claim 5, wherein
said liquid-crystal panel has an electrode on which a plurality of slit-shaped apertures are formed; and
said electrode is provided so that the longitudinal direction of said slit-shaped apertures is parallel to the width direction of said liquid-crystal panel.

7. The display apparatus according to claim 2, wherein
said optical film is a phase-difference plate.

8. The display apparatus according to claim 1, wherein
said display panel includes
a liquid-crystal panel driven by a vertical electric-field method,
an upper polarization plate provided on said upper-surface side of said liquid-crystal panel to transmit only light experiencing polarization determined in advance, and
a lower polarization plate provided on said lower-surface side of said liquid-crystal panel to transmit only light experiencing polarization determined in advance;
said optical film has an upper optical film provided between said liquid-crystal panel and said upper polarization plate as well as a lower optical film provided between said liquid-crystal panel and said lower polarization plate; and
said optical film is formed so that said lower optical film is thicker than said upper optical film.

9. The display apparatus according to claim 8, wherein
said upper optical film is a one-axis A plate for circular polarization of light; and
said lower optical film is configured to include a one-axis A plate for circular polarization of light and a one-axis C plate for view-angle compensation.

10. The display apparatus according to claim 8, wherein
said upper optical film is a one-axis A plate for circular polarization of light; and
said lower optical film is configured to include a one-axis A plate for circular polarization of light and an O plate for view-angle compensation.

11. The display apparatus according to claim 1, wherein
said touch sensor and said display panel are integrated with each other.

12. Electronic equipment including a display apparatus comprising:
a display panel having a display area displaying an image;
a touch sensor provided to overlap the surface of at least a portion of said display area; and
an optical film which is provided so that a laminated layer formed on the lower-surface side of said display panel is thicker than a layer formed on the upper-surface side of said display panel and is provided with a view-angle compensation function.
